(19) United States
(12) Patent Application Publication
(10) Pub. No.: US 2024/0362410 A1
(43) Pub. Date: Oct. 31, 2024

(54) METHODS AND SYSTEMS FOR GENERATING ENGAGING KNOWLEDGE ARTICLES

(71) Applicant: Wildboom Corporation dba Intellective, Palo Alto, CA (US)

(72) Inventors: Ritesh Dalal, Palo Alto, CA (US); Abdul Halabieh, Danville, CA (US)

(21) Appl. No.: 18/645,162

(22) Filed: Apr. 24, 2024

Related U.S. Application Data
(60) Provisional application No. 63/498,109, filed on Apr. 25, 2023.

(51) Int. Cl. G06F 40/186; G06F 9/451; G06F 40/143

(52) U.S. Cl. CPC G06F 40/186; G06F 9/451; G06F 40/143

(57) ABSTRACT

Various embodiments provide methods and systems for generating an article. The method is performed by a server system. The method includes receiving a first input corresponding to selection of an article generation method. In addition, the method includes accessing a template. Further, the method includes receiving a second input corresponding to selection of one or more components from a set of components. Furthermore, the method includes embedding the selected one or more components in the template. Moreover, the method includes receiving at least one Artificial Intelligence (AI) based recommendation for generating the article. Also, the method includes generating the article based, at least in part, on the embedded one or more components and the at least one AI based recommendation.

### TECHNICAL FIELD

The present disclosure relates to the field of article authoring and, more particularly, to computer-implemented methods and systems for generating engaging knowledge articles.

### BACKGROUND

Large enterprises or organizations spend a lot of time and resources on solving tickets raised by their employees. Mostly, the tickets include support and addressing tickets related to the enterprises/organizations. The time and resources consumed in solving such tickets can be saved by enabling the employees to solve their queries based on guidance from the enterprises/organizations. The most effective method of providing such guidance is by providing a knowledge base of information. The knowledge base may include knowledge articles that must be actionable and effective so that the employees can easily understand the instructions and effectively solve their queries on their own.

To achieve this, enterprise cloud platforms provide computer-implemented authoring capabilities. Generally, computer-implemented authoring may include creating and editing articles with the facilitation of a software application in a What You See Is What You Get (WYSIWYG) environment. In addition, WYSIWYG enables a user to see on a display monitor exactly how the article will appear to readers once published. For example, in a word processor, the background looks exactly like a sheet of paper. The user is then allowed to type on the paper (i.e., word processor), change the font of the text, format paragraphs, insert objects, and observe the effect immediately. Once the document is finished and printed, it looks exactly similar to how it looked on the monitor screen.

However, computer-implemented authoring is a complex task as it involves supporting an author's creativity to ensure consistency during authoring. For example, creating an article on the right template can significantly enhance the quality of the article. On the other hand, if the article is written on the wrong template, the author may end up with an article completely different than what was initially planned. In addition, conventional computer-implemented authoring includes only basic tools such as basic typography, tables, and other basic elements. Thus, generating high-quality articles with consistency is difficult to achieve. For example, the final article may depend upon various aspects such as adequate content resolution and format, matching visual design, semantic suitability and expressiveness, and the like.

Thus, there exists a technological need for an enhanced WYSIWYG platform that enables an author to generate quality articles.

### SUMMARY

Various embodiments of the present disclosure provide systems and methods for generating an article.

In an embodiment, a computer-implemented method is disclosed. The method includes receiving, by the server system, a first input corresponding to the selection of an article generation method. In addition, the method includes accessing, by the server system, a template for generating the article. Further, the method includes receiving, by the server system, a second input corresponding to selection of one or more components from a set of components. Furthermore, the method includes embedding, by the server system, the selected one or more components in the template. Moreover, the method includes receiving, by the server system, at least one Artificial Intelligence (AI) based recommendation for generating the article. Also, the method includes generating, by the server system, the article based, at least in part, on the embedded one or more components and the at least one AI based recommendation.

In another embodiment, a server system is disclosed. The server system includes a memory configured to store instructions, a communication interface, and a processor in communication with the memory and the communication interface. The processor is configured to execute the instructions stored in the memory and thereby cause the server system to perform, at least in part, to receive a first input corresponding to selection of an article generation method. The server system is caused to access a template to generate the article. The server system is caused to receive a second input corresponding to selection of one or more components from a set of components. Further, the server system is caused to embed the selected one or more components in the template. Furthermore, the server system is caused to receive at least one Artificial Intelligence (AI) based recommendation to generate the article. Moreover, the server system is caused to generate the article based, at least in part, on the embedded one or more components and the at least one AI based recommendation.

### BRIEF DESCRIPTION OF THE FIGURES

For a more complete understanding of example embodiments of the present technology, reference is now made to the following descriptions taken in connection with the accompanying drawings in which:

FIG. 1 illustrates an exemplary representation of an environment related to at least some embodiments of the present disclosure;

FIG. 2 illustrates a simplified block diagram of a server system, in accordance with an embodiment of the present disclosure;

FIG. 3 illustrates an exemplary representation of a UI depicting various article generation methods for generating a new article, in accordance with an embodiment of the present disclosure;

FIG. 4 illustrates an exemplary representation of a UI depicting a set of components, in accordance with an embodiment of the present disclosure;

FIG. 5 illustrates an exemplary representation of a UI depicting a plurality of templates, in accordance with an embodiment of the present disclosure;

FIG. 6 illustrates an exemplary representation of a UI depicting an embedded document in an article, in accordance with an embodiment of the present disclosure;

FIG. 7 illustrates an exemplary representation of a UI depicting embedded media content in the article, in accordance with an embodiment of the present disclosure;

FIG. 8 illustrates an exemplary representation of a UI depicting the article with an embedded watermark, in accordance with an embodiment of the present disclosure;

FIG. 9A-9B collectively illustrates exemplary representation of a UI depicting various settings associated with an article builder application, in accordance with an embodiment of the present disclosure;

FIG. 10 illustrates an exemplary representation of a UI depicting a preview of the article, in accordance with an embodiment of the present disclosure;

FIGS. 11A-11F collectively illustrate example representation of various user interfaces (UIs) related to the artificial intelligence service, in accordance with an embodiment of the present disclosure;

FIG. 12 illustrates a block diagram representation of enabling the author to create an article, in accordance with an embodiment of the present disclosure;

FIG. 13 is a flowchart illustrating a computer-implemented method for enabling an author to create a quality article, in accordance with an embodiment of the present disclosure; and

FIG. 14 shows a simplified block diagram of a computing device capable of implementing the various embodiments of the present disclosure.

The drawings referred to in this description are not to be understood as being drawn to scale except if specifically noted, and such drawings are only of example in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification does not necessarily refer to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The terms “What You See Is What You Get” and “WYSIWYG”, used interchangeably throughout the description may refer to an editing environment or authoring tool that enables a user to visualize on a monitor screen exactly how a document will appear after publishing. In one example, in a WYSIWYG editor environment, an author can create an article in an editor window, and the author can drag and drop elements such as images, forms, and tables visually and see the changes instantly on the monitor screen.

The terms “author” and “user”, used interchangeably throughout the description may refer to a person who is a writer of an article in the WYSIWYG editor environment. In one example, the author can be associated with an enterprise organization and may create the article for the enterprise organization.

The term “readers” used throughout the description may refer to individuals who may read the article created or written by the author. The readers may read the article on their corresponding computing devices (e.g., laptops, desktops, mobile phones, tablets, etc.).

### Overview

Various embodiments of the present disclosure provide methods and systems for enabling an author to write quality articles in a What You See Is What You Get (WYSIWYG) editing environment. In one implementation, the author may write articles for an enterprise organization. In general, the enterprise organization may refer to a large business that has a sizeable number of employees. The WYSIWYG editing environment provides a drag-and-drop User Interface (UI) for the author to generate high-quality articles. The author can use any computing device (with access to a network) to generate the high-quality articles from any geographic location.

As mentioned above, computer-based authoring is a complex task. There is a need to provide an enhanced WYSIWYG editing environment to enable the author to write quality articles. Various embodiments of the present disclosure provide a server system configured to enable the author to generate quality articles. The server system is configured to provide a visual article builder (i.e., WYSIWYG editor window) to the author, using which the author can generate quality articles. More specifically, the server system is configured to provide various visual blocks, using which the author can create quality articles.

The server system is configured to receive a first input corresponding to selection of an article generation method, from the author. In some embodiments, the article generation method may include a first method related to selection of components, a second method related to selection of template, and a third method related to selection of an artificial intelligence (AI) service.

The server system is configured to access a template for generating the article. For example, the author can select the template in the second method or the third method. Based on the selected template, the server system is configured to access the template. The server system is also configured to receive a second input corresponding to selection of one or more components from a set of components. In an implementation, the server system provides the author with a template library including pre-existing templates. The template library may be fetched online via the network. The author has an option to choose a template for the article from the pre-existing templates.

In another embodiment, the server system provides the author with an option to add various components (e.g., anchor, media content, accordion, etc.) in the article. The author has an option to choose the one or more components from the various components for preparing the article. The author can drag and drop the one or more components anywhere in the article as per requirement.

In yet another embodiment, the server system enables the author to connect with an artificial intelligence (AI) service to generate the article. In an implementation, the Al service can be associated with the server system. In another implementation, the AI service can be an external third-party AI service. The first input and the second input can be received via an input device including, but not limited to, a keyboard, a mouse, a joystick, and a touchscreen.

The server system is configured to embed the one or more components in the template. The server system is configured to connect with the Artificial Intelligence (AI) service. In one implementation, the AI service is a third-party AI service platform. The AI service is configured to provide at least one AI-based recommendation for generating the article. In some examples, the AI based recommendation may include content recommendation, component recommendation, or recommendation of placement of content or component in the article.

Upon finalization, the server system is configured to generate and display a final article on a display of the computing device of the author. The server system is also configured to publish the final article on the internet. The final article can then be read by readers across the world upon publication of the final article for the public. For example, the author can set access control for the final article to be viewable by the public.

Further, various embodiments of the present disclosure offer multiple advantages and technical effects. For instance, the present disclosure enables the easy creation of actionable knowledge articles that drive self-service. Further, various embodiments of the present disclosure provide advanced design capabilities right in a computing device of an author with a WYSIWYG interface with no coding requirement. Furthermore, reusable blocks and templates are provided to the author to help drive consistency in information design. Moreover, the author can add rich media embedding that can further enhance the experience of readers without the need to download additional files. Various embodiments of the present disclosure also save valuable time for authors and avoid blank page syndrome while generating new knowledge (i.e., articles).

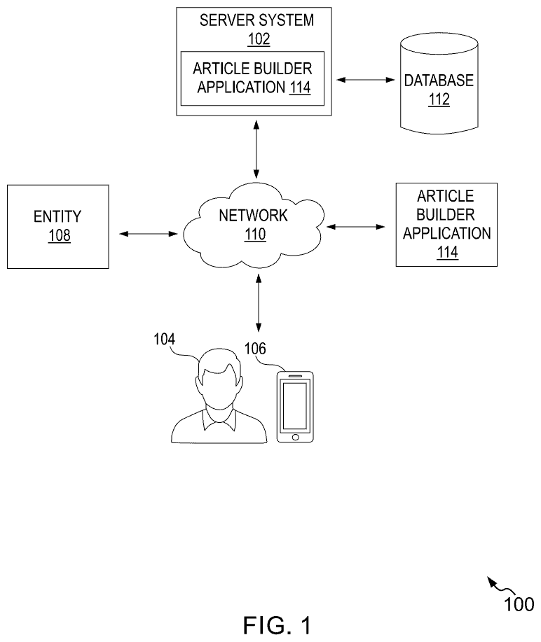

Various example embodiments of the present disclosure are described hereinafter with reference to FIGS. 1 to 14.

FIG. 1 illustrates an exemplary representation of an environment 100 related to at least some embodiments of the present disclosure. Although the environment 100 is presented in one arrangement, other embodiments may include the parts of the environment 100 (or other parts) arranged otherwise depending on, for example, generating quality articles for an enterprise organization.

The environment 100 generally includes a server system 102, an author 104, a computing device 106, an entity 108, a database 112, and an article builder application 114, connected to, and in communication with (and/or with access to) a communication network (e.g., a network 110).

Various entities in the environment 100 may connect to the network 110 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, future communication protocols or any combination thereof. For example, the network 110 may include multiple different networks, such as a private network made accessible by the server system 102 and a public network (e.g., the Internet, etc.) through which the server system 102 may communicate.

In an embodiment, the server system 102 is deployed as a standalone server or can be implemented in the cloud as software as a service (SaaS). In an embodiment, the server system 102 provides or hosts the article builder application 114 for the author 104 to create articles for the entity 108. In a preferred embodiment, the author 104 is associated with the entity 108. For example, the author 104 may correspond to an individual working with the entity 108 (e.g., the enterprise organization). It is shown in FIG. 1 that a single author 104 is writing the article for the entity 108, however, it is noted that there can be any number of authors writing any number of articles for the entity 108.

In an embodiment, an instance of the article builder application 114 is accessible in the computing device 106. This is enabled by installing the article builder application 114 in the computing device 106, which enables the author 104 and/or the entity 108 to be able to access the server system 102 on the computing device 106. In an embodiment, the computing device 106 is associated with the entity 108. In another embodiment, the computing device 106 is associated with the author 104. In yet another embodiment, the computing device 106 is associated with the entity 108 and/or the author 104.

For instance, the computing device 106 may correspond to any suitable electronic or computing device 106 such as a smartphone, a personal computer, a laptop, a personal digital assistant (PDA), an electronic tablet, a desktop computer, a wearable device such as a smartwatch, a smart device such as smart television (TV) or smart appliance, etc., among other suitable electronic devices. Further, the author 104 may correspond to any individual, organization, representative of a corporate entity, a non-profit organization, or any other person who wants to write an article. In an embodiment, the article may be associated with the entity 108. In another embodiment, the article may not be associated with the entity 108.

In an example, the article may be related to a leave policy of the entity 108. In another example, the article may be related to various services offered by the entity 108. In yet another example, the article may be related to Frequently Asked Questions (FAQs) about the entity 108. In yet another example, the article may be about questions related to open enrollment. In yet another example, the article may be about “how to change password”. In an implementation, the author 104 may want to generate and/or write the article in relation to the entity 108.

In some embodiments, the entity 108 includes, but may not be limited to, a business, an institution, an organization, an enterprise organization, a factory, and the like. In an example, the entity 108 may correspond to an enterprise organization that wants the author 104 to generate articles for its employees. In general, the enterprise organization is a large business that has the size and/or resources to dominate a specific market. In addition, the enterprise organization is usually characterized by high revenue and has a large number of employees.

In another example, the entity 108 may relate to a financial institution (e.g., a bank, a Non-Banking Financial Institution (NBFC), an insurance seller, etc.) that wants the author 104 to generate articles related to finance. In yet another example, the entity 108 may relate to small and micro businesses that want to generate articles related to their business. In yet another example, the entity 108 may relate to any organization that wants to generate articles and/or documents.

In an embodiment, the author 104 accesses the server system 102 on the computing device 106. In another embodiment, the entity 108 accesses the server system 102 on the computing device 106. The server system 102 is further configured to provide a UI that displays a What You See Is What You Get (WYSIWYG) editor window on the computing device 106 of the author 104. In one embodiment, the article builder application 114 is configured to provide the WYSIWYG editor window on the computing device 106 of the author 104. The author 104 may then utilize the WYSIWYG editor window to generate the article. In an implementation, the server system 102 may render and display the UI on the computing device 106 of the author 104.

The database 112 may be adapted to store information, such as, but not limited to, pre-existing templates, previously published articles, pre-stored media components, metadata, existing media content, and the like. In addition, the database 112 may also include media content or attachment(s) (e.g., documents, videos, audios, etc.). In an implementation, the database 112 is associated with the server system 102. In an implementation, the database 112 can be accessed, viewed, managed, and/or updated with the facilitation of a database management system (DBMS), relational database management system (RDBMS), or the like.

The number and arrangement of systems, devices, and/or networks shown in FIG. 1 are provided as an example. There may be additional systems, devices, and/or networks; fewer systems, devices, and/or networks; different systems, devices, and/or networks, and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally, or alternatively, a set of systems or a set of devices of the environment 100 may perform one or more functions described as being performed by another set of systems or another set of devices of the environment 100.

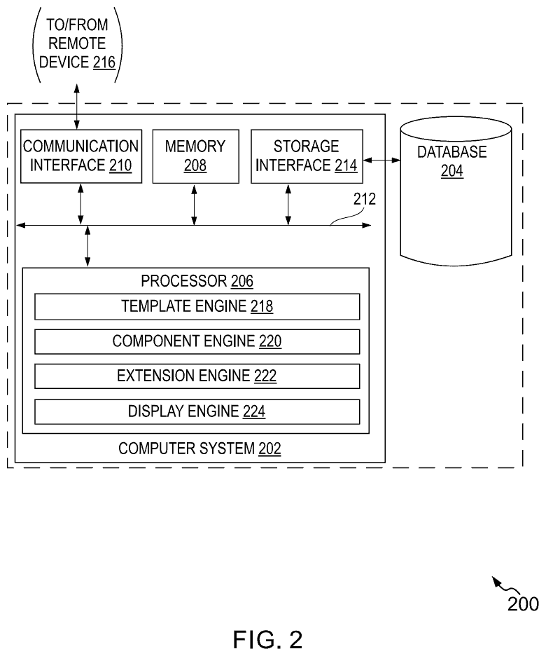

FIG. 2 illustrates a simplified block diagram of a server system 200, in accordance with an embodiment of the present disclosure. For example, the server system 200 is identical to the server system 102 as described in FIG. 1. In some embodiments, the server system 200 is embodied as a standalone physical server and/or having a cloud-based and/or software as a service based (SaaS-based) architecture. The server system 200 is configured to enable the author 104 to generate engaging articles for the entity 108 as per requirement.

The server system 200 includes a computer system 202 and a database 204. The computer system 202 includes at least one processor, such as a processor 206 for executing instructions, a memory 208, a communication interface 210, a bus 212, and a storage interface 214. The bus 212 enables entities of the computer system 202 to communicate with each other. The database 204 is an example of the database 112 of FIG. 1.

In some embodiments, the database 204 is integrated within the computer system 202. For example, the computer system 202 may include one or more hard disk drives as the database 204. The storage interface 214 is any component capable of providing the processor 206 with access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204.

It is to be noted that although the computer system 202 is depicted to include only one processor, the computer system 202 may include a greater number of processors therein. The processor 206 includes a suitable logic, circuitry, and/or interfaces to execute computer-readable instructions for performing one or more operations for generating the article. Examples of the processor 206 include, but are not limited to, an Application-Specific Integrated Circuit (ASIC) processor, a Reduced Instruction Set Computing (RISC) processor, a Complex Instruction Set Computing (CISC) processor, a Field-Programmable Gate Array (FPGA), and the like.

In an embodiment, the memory 208 is capable of storing the computer-readable instructions. Examples of the memory 208 include a Random-Access Memory (RAM), a Read-Only Memory (ROM), a removable storage drive, a Hard Disk Drive (HDD), and the like. It will be apparent to a person skilled in the art that the scope of the disclosure is not limited to realizing the memory 208 in the server system 200, as described herein. In another embodiment, the memory 208 may be realized in the form of a database server or cloud storage working in conjunction with the server system 200, without departing from the scope of the present disclosure.

The processor 206 is operatively coupled to the communication interface 210 such that the computer system 202 is capable of communicating with a remote device 216 such as the computing device 106, or with the entity 108 connected to the network 110 (as shown in FIG. 1). In one embodiment, the processor 206 is configured to facilitate installing an instance of the article builder application 114 corresponding to the server system 200 on the computing device 106. This enables the implementation of a plurality of functionalities by multiple entities described in the disclosure.

It is to be noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

The processor 206 is depicted to include a template engine 218, a component engine 220, an extension engine 222, and a display engine 224. It should be noted that components described herein, can be configured in a variety of ways, including electronic circuitries, digital arithmetic, and logic blocks, and memory systems in combination with software, firmware, and embedded technologies.

In an implementation, the processor 206 is configured to render the WYSIWYG editor window on the computing device 106 of the author 104. In another implementation, the server system 200 is configured to render the WYSIWYG editor window on the computing device 106 of the author 104. In yet another implementation, the article builder application 114 is configured to render the WYSIWYG editor window on the computing device 106 of the author 104.

In one implementation, the processor 206 is configured to render a User Interface (UI) on the computing device 106 of the author 104. In addition, the rendered UI depicts the WYSIWYG editor window rendered on the computing device 106 of the author 104.

The template engine 218 includes suitable logic and/or interfaces to receive a first input corresponding to selection of an article generation method from the author 104. For example, the processor 206 is configured to render a UI on the computing device 106 of the author 104. The rendered UI enables the author 104 to select the article generation method. The article generation method may include a first method related to selection of components, a second method related to selection of template, and a third method related to selection of an artificial intelligence (AI) service.

In an example, the author 104 can select any one of the first method, the second method, or the third method. The first method enables the author 104 to select the one or more components from the set of components. The second method enables the author 104 to select a template from the template library. The third method enables the author 104 to select the AI service to generate the article.

The template engine 218 is configured to access the template. For example, the author 104 selects the second method or the third method as the article generation method. Then, the author 104 is allowed to select the desired template. Upon selection of the desired template, the processor 206 is configured to access the template.

The component engine 220 includes suitable logic and/or interfaces to receive a second input corresponding to selection of one or more components from a set of components. In an example, in case the author 104 selects the first method, the component engine 220 is configured to receive the one or more components from the set of components as the second input.

The component engine 220 is configured to enable the author 104 to drag and drop the one or more components in the template in the WYSIWYG editor window to generate the article, resulting in rich, graphical, and interactive articles. For example, the author 104 is allowed to select the template from the template library. The template library may depict various templates based on the required theme of the article (for example, business, personal, interactive, etc.).

It is noted that the component engine 218 is configured to provide the author 104 with WYSIWYG design capabilities (e.g., templates, etc.) for authoring and designing content presentations.

In one example, the template engine 218 is configured to enable the author 104 to select required template from pre-existing templates in the template library. The author 104 can then select the required template from the pre-existing templates (i.e., template library). In particular, the author 104 can drag and drop the selected template in the WYSIWYG editor window. In one implementation, the processor 206 is configured to provide easy to use WYSIWYG editor window on the computing device 106 of the author 104.

The processor 206 is configured to provide the author 104 with template recommendations for enabling the author 104 to create visually stunning articles. Furthermore, the processor 206 is configured to eliminate the coding need for the author 104. The one or more components include at least one of carousels, tabs, media elements, embedding documents, knowledge blocks, accordions, anchors, dynamic services, and the like. The author 104 can drag and drop the one or more components anywhere in the WYSIWYG editor window as per requirement. In one embodiment, the second input is received via the WYSIWYG editor window.

In one implementation, the component engine 220 enables the author 104 to add a video component to the article. The author 104 has an option to embed the video component in the article from various sources (e.g., online, offline, etc.). The author 104 has an option to simply drag and drop the video component anywhere in the WYSIWYG editor window and paste the embed code from the settings. In addition, the component engine 220 enables the author 104 to choose a required aspect ratio from pre-defined aspect ratios for the video component. In general, the aspect ratio is a proportional relationship between a video's width and height.

In one implementation, the component engine 220 enables the author 104 to add component (e.g. tabs) in the article. In one implementation, tabs are added to enable the author 104 to structure the article for better readability. Generally, tabs are added when the article has various orthogonal items. Further, the addition of tabs facilitates the reader to interact with each item to independently view its content, thereby reducing the cognitive load of reading lengthy content.

In one implementation, the component engine 220 enables the author 104 to embed a document (e.g., a word document, a Portable Document Format (i.e., PDF), etc.) in the article. The document is treated as a component and can be dragged and dropped anywhere in the WYSIWYG editor window. Embedding the document directly into the article enables a superior attachment consumption experience where the document can be viewed directly in the article without the need to download and view the document separately.

In one implementation, the component engine 220 enables the author 104 to peek into existing knowledge blocks (i.e., articles) and see their content. In this manner, the component engine 220 enables the author 104 to decide which knowledge blocks they want to include in the article, and to also preview the same for the reader.

In one implementation, the component engine 220 enables the author 104 to add a carousel component in the article. In general, a carousel is added to enable the author 104 to interact with the article. Further, the carousel component enables the author 104 to add more content into less area. In one implementation, the author 104 can select parameters (such as a number of slides, layout, content, images, call to action items, etc.) associated with the carousel.

In one implementation, the component engine 220 enables the author 104 to insert an accordion component in the article. In general, long articles (having a lot of text) are hard to parse and consume by readers. With the use of the accordion component, the content can be revealed when a reader selects a particular accordion, thereby providing progressive disclosure. Thus, the usage of the accordion enhances the article content consumption. The component engine 220 enables the author 104 to drag and drop the accordion component anywhere in the article as per requirement. In general, accordions are used to show and hide content (e.g., as a toggle to show and hide content).

In one implementation, the component engine 220 enables the author 104 to add an anchor or a table of contents to the article. The author 104 can drag and drop the anchor component anywhere in the WYSIWYG editor window as per requirement. The author 104 can then add the links to the anchor to enable a reader to click on the anchor to navigate to a linked section of the article. In this manner, the component engine 220 makes it easier for a reader to navigate the article.

For example, the table of contents or the anchor may include five sections of the article. The reader can click on the fourth section in the anchor to navigate directly to the fourth section in the article. In this manner, the component engine 220 facilitates easier navigation within a long article for the reader.

In one implementation, the component engine 220 enables the author 104 to integrate dynamic services (e.g., third-party services) in the article to enhance the authoring experience. In an example, the article can be configured with a spell checker third-party service. In another example, the article can be configured with a language translation third-party service. In yet another example, the article can be configured with an AI based third-party service.

In one implementation, the component engine 220 is linked with the extension engine 222. The extension engine 222 includes suitable logic and/or interfaces to manage the dynamic services. In one implementation, the extension engine 222, along with the component engine 220 is responsible for managing the dynamic services. In one implementation, the extension engine 222 is configured to embed the selected one or more components in the template.

In an example, the dynamic services include an AI service and/or tool (hereinafter referred to as the AI service). In another example, the dynamic services include a library (e.g., a media library). The AI service may further facilitate the author 104 to generate interactive multimedia content and graphics for the article. The extension engine 222 may enable the author 104 to integrate the dynamic services in a scratchpad, an image selector, an edit mode in the WYSIWYG editor window, and the like.

In one implementation, the entity 108 can use a configuration utility to decide pre-existing components and templates that the author 104 can use. In addition, the entity 108 can define or specify the settings corresponding to the pre-existing components and templates that the author 104 can access. In this manner, the entity 108 can have complete control over the governance of the article. In one example, the entity 108 can define the control or settings of the author 104 in the article builder application 114.

In one implementation, the extension engine 222 is configured to receive at least one AI based recommendation for generating the article. The extension engine 222 may also receive media components recommendations from the library. In particular, the processor 206 is configured to establish a secure communication with the AI service and library via Representational State Transfer Application Programming Interface (RESTful API). In one example, the AI service is a third-party external service. In one example, the library is a third-party library. The extension engine 222 is then configured to receive the at least one AI based recommendation and media components (e.g., images, videos, etc.) from the AI service and library.

The AI based recommendation may include at least one of content recommendation, media element recommendation, and component recommendation. In one example, the AI service may generate content recommendation based on various inputs such as the title or context of the article, using generative AI. In addition, the AI service may recommend media content and components to be embedded in the article. Further, the AI service may also recommend the position of placement of the media content and components based on artificial intelligence. For example, the AI service may analyze the user engagement metrics on the existing authored articles and their respective content. Based on this analysis, the AI service may recommend the position of placement of the media content and components to maximize user engagement.

Once the editing of the article is finished, the author 104 can save the article and exit from the WYSIWYG editor window. In one implementation, the author 104 has an option to save the article as a template, such that other authors can use this article as a template for future use. Once the article is saved, the author 104 can preview the article in a preview window. The extension engine 222 is then configured to generate the article based, at least in part, on the embedded one or more components and the at least one AI based recommendation. The AI based recommendation may facilitate the generation of the article in a visually rich and interactive format.

The display engine 224 includes suitable logic and/or interfaces for rendering the article on a display of the computing device 106 of the author 104 before publishing. The display engine 224 is configured to render the generated article on the computing device 106 of the author 104 exactly as the article will be displayed on the computing devices of readers (not shown in figures) after publishing. The author 104 can then choose to publish the article over the network 110 (e.g., Internet, Intranet, etc.).

For example, the server system 200 is configured to render a UI on the display of the computing device 106 of the author 104. UI displays the WYSIWYG editor window on the computing device 106 of the author 104. The author 104 can then have an option to select a template from pre-existing templates. In addition, the author 104 can compose the article by stacking pre-designed blocks of content on a blank canvas. The pre-defined blocks of content may include a title, a heading, a paragraph, media content, and the like (i.e., the one or more components).

It is noted that the WYSIWYG editor window enables the author 104 to embed the one or more components in the article. For example, the author 104 has an option to embed any media content (e.g., an image, an audio, an animation, a Graphics Interchange Format (GIF), and the like). In addition, the media content can be placed anywhere in the article as per the requirement of the author 104.

It is noted that the author 104 also has an option to design its own template or design. The author 104 can then save and share the template design with other authors associated with the entity 108. In this manner, the templates can be shared internally within the authors to support the reusability of the templates.

In one embodiment, the server system 200 is configured to provide the entity 108 with granular control over the design capabilities. For example, the server system 200 enables the entity 108 to restrict certain features (e.g., design capabilities) of the article builder application 114 to specific authors (e.g., the author 104) to centralize the design process and promote reusability and consistency of the articles.

In one implementation, the processor 206 is configured to calculate one or more health scores associated with one or more published articles. In particular, each health score is associated with each published article. The one or more health scores are calculated based at least on the analysis of one or more parameters. The one or more parameters include at least one of the orphaned articles, unused articles, least read articles, most popular articles, search unclicked articles (i.e., articles appearing in search results but not interacted with), and the like.

In an embodiment, the one or more parameters include orphaned articles (i.e., either articles having no author, or the author is no longer working with the entity). For the orphaned articles, the processor 206 is configured to assign new authors. In another embodiment, the one or more parameters include unused articles. The unused articles need to be archived to reduce the amount of data the search engine has to deal with for better performance.

In yet another embodiment, the one or more parameters include articles with low reader scores (i.e., least read articles). Such articles need to be rewritten to improve their reader score. In yet another embodiment, the one or more parameters include the most popular articles. Such articles can be templatized to set them as existing templates.

In yet another embodiment, the one or more parameters include “search unclicked articles”. The “search unclicked articles” may relate to the articles that show up in search results of a search but are not opened and then followed by another search. For example, the reader may search for articles related to ‘global warming’. Article ‘A’, article ‘B’, and Article ‘C’ may show up in the search results. However, the reader may not open up any of these articles and again modify the strings for the search. In this situation, Article ‘A’, Article ‘B’, and Article ‘C’ may relate to search unclicked articles. The “search unclicked articles” may be required for better tagging and re-evaluating reasons behind their lack of interaction.

In one implementation, the determination of search unclicked articles provides insights about the articles that were part of the search results and their relevancy (or lack thereof) to the search keywords, to the server system 200. The identification of search unclicked articles helps to adjust their tagging or determine if they have a gap to support the search keywords that resulted in zero clicks on the results.

For determining the orphaned articles, the processor 206 is configured to access the database 112. In particular, the processor 206 is configured to access a table stored in the database 112. Further, the processor 206 is configured to check the author field in the table to determine the articles that have no author value stored in the author field or the author is no longer with the entity 108. In case the author field is empty, or the author is inactive, the processor 206 is configured to determine that the article is an orphaned article.

In one implementation, the processor 206 is configured to determine articles with low reader scores. In particular, the processor 206 is configured to determine the rating field in the table stored in the database 112. If the rating field has a value of 1 or 2, then the processor 206 is configured to identify the corresponding article as an article with a low reader score.

For determining the unused articles, the processor 206 is configured to access the database 112. In particular, the processor 206 is configured to access a table stored in the database 112, which likely records information about user interactions with the articles. The table may include details such as article Identities (IDs), user IDs, timestamps of accesses, and other relevant data. Further, the processor 206 is configured to check whether the article has any corresponding user interactions. In case there is an article that is published and does not exist in the table, the processor 206 is configured to determine that the article is an unused article.

In one embodiment, the processor 206 is configured to determine the articles having the most number of user interactions. In case articles have the most number of user interactions, the processor 206 is configured to determine that the article as the most popular article. The most popular articles can then be selected for templatized articles.

In one implementation, the processor 206 is configured to convert the text-heavy articles into visually rich interactive articles with a single click with the facilitation of the AI service. For example, the server system 200 is configured to receive the template selection from the author 104. In addition, the server system 200 is configured to receive the content of the article from the author 104. Further, the server system 200, using the extension engine 222, is configured to generate the article based at least on the selected template, the content of the article, and the at least one AI based recommendation. The server system 200 is configured to add the one or more components and automatically fit in the content of the article in the one or more components to generate the final article.

The AI service enables the authors to convert text-heavy articles into engaging, media rich, easy to read articles with the facilitation of AI using a single click. In one implementation, the server system 200 is configured to convert a group of text heavy articles into visually rich interactive articles in a single click. For example, the author 104 may select a group of articles in a UI. The group of articles needs to be converted using AI. The author 104 may then click on a button to enable the server system 200 to process and convert the articles using AI.

In one implementation, the author 104 selects an existing template for their article. The author 104 may then select AI as a service to generate their article. Further, the author 104 may prompt the AI service with the subject and outline of the article. The server system 200 may establish secure communication with the AI service to add the one or more components to the article. The server system 200 may then interface with various image libraries (i.e., the library) to select the appropriate images required for the article. The server system 200 is then configured to generate the article based on the template, the added one or more components, and the selected appropriate images.

In one implementation, the author 104 may provide details such as title, audience (e.g., internal employees, external employees, etc.), keywords, and tone (e.g., friendly, etc.) to the AI service to generate the article. In one implementation, the AI service can perform tasks such as analyzing tone, suggesting topical content based on author criteria, and conversationally generating text. This allows for Natural Language Processing (NLP) and generation capabilities within the server system 200.

The AI service also leverages Large Language Models (LLM). Generally, LLMs are advanced AI models capable of processing and generating human-like text. Specifically, LLM is employed to generate search queries and fetch results from third-party image libraries. By utilizing LLM, the server system 200 can efficiently generate complex search queries and retrieve relevant image results, enhancing the search functionality and enriching user experience.

In one implementation, the processor 206 is configured to enable the author 104 to control the layout for the same article for different screen sizes of different computing devices. For example, in case an article has large images that do not render properly on mobile devices with smaller screens, the author 104 can choose to not display such images in case the article is accessed on mobile devices with smaller screens. The author 104 may use the article builder application 114 to control the layout for the article.

In one implementation, the article builder application 114 is configured to enable the author 104 to add links and anchors within the editor window itself. Thus, the server system 200 is configured to enable the author 104 to manage the links and anchors in a similar manner as writing in the editor window itself. For example, the author 104 can select the text (on which the author 104 wants to add a link) in the editor window. The author 104 can then click on the ‘insert link’ (rendered on UI) button to add a hyperlink to the selected text.

In one implementation, the processor 206 is configured to enable the author 104 to connect with the AI service and library. In one implementation, the extension engine 222 is configured to establish a secure communication between the server system 200 and the AI service and private library of the author 104. Further, the author 104 may select their private media elements (e.g., images, videos, etc.) for insertion in the article.

In one implementation, the display engine 224 is configured to display an interactive dashboard on the computing device 106 of the author 104. The interactive dashboard displays various insights about the various already published articles. Generally, authors are not aware of the performance of their published articles. Therefore, the processor 206 is configured to render a UI of the interactive dashboard on the respective computing devices (e.g., the computing device 106) of the authors (e.g., the author 104). The interactive dashboard depicts the insights on the health of the various articles published by the authors. These insights enable the authors to make data driven decisions to improve the performance of their articles.

In one implementation, the server system 200 is configured to preview the article on the computing device 106 of the author 104 before publishing. In the preview mode, the author 104 is allowed to interact with the one or more components (such as the accordion, etc.). In one implementation, the server system 200 is configured to display the health score corresponding to each article in the interactive dashboard.

For receiving the at least one AI based recommendation, the extension engine 222 is configured to receive an author request from the computing device 106 of the author 104. The author request includes at least one of: subject of the article, relevant keywords, the target audience for the article, and the desired tone of the article. In one implementation, the extension engine 222 is configured to transmit the author request to the AI service.

In an embodiment, the AI service and the library are internal components of the extension engine 222. In another embodiment, the AI service and the library are external components of the extension engine 222. In yet another embodiment, the AI service and the library are private components.

Further, the processor 206 is configured to process the author request based at least on the AI service to generate a list of relevant topics. The generated list of relevant topics is rendered on the display of the computing device 106 of the author 104. For example, the extension engine 222 is configured to send the author request to the AI service. The AI service is then configured to process the author request to generate the list of relevant topics. Further, the AI service is configured to transmit the generated list of relevant topics to the extension engine 222. The display engine 224 is then configured to render the generated list of relevant topics on the display of the computing device 106.

The author 104 may then select one or more topics from the generated list of relevant topics. The server system 200 is then configured to receive an author response including a selection of one or more topics from the generated list of relevant topics. The one or more topics may be manually selected by the author 104.

Furthermore, the server system 200 is configured to update Document Object Model (DOM) of the template based at least on the author response. DOM represents the structure of the content template, and modifications are made to align it with the template and other relevant attributes specified by the author 104. The server system 200 is then configured to map each section of the DOM to custom attributes. The custom attributes may include data attributes (for example, data identifier), event handling attributes, styling attributes, data storage attributes, and the like.

Moreover, the server system 200 is configured to receive content requests from the computing device 106 of the author 104. The content requests are related to content for each section of the DOM. The server system 200 is further configured to process the content requests based at least on one or more techniques (e.g., virtual chatbot, LLM, generative AI, etc.) via the AI service to generate content responses. Furthermore, the server system 200 is configured to generate the article based at least on the generated content responses. The content responses may include text, images, and other multimedia elements that fulfill the requirements specified by the author 104 for each section of the DOM.

In one implementation, the server system 200 is configured to establish communication with external LLMs via RESTful API calls. Such calls are defined using scripted extension points and can also be extended to enable the authors to include private LLMs that are RESTfully accessible.

In one implementation, the server system 200 is configured to enable the author 104 to drag and drop the document viewer component via an embedded iframe component. This enables the reader to view the document (for example in Portable Document Format (PDF)) in the article itself without the need for opening the document in a separate window. In one implementation, the extension engine 222 is configured to enable server-side code customization to enhance client-side functionality, acting as an adapter for standardized interactions with external resource Application Programming Interfaces (APIs) and codebase.

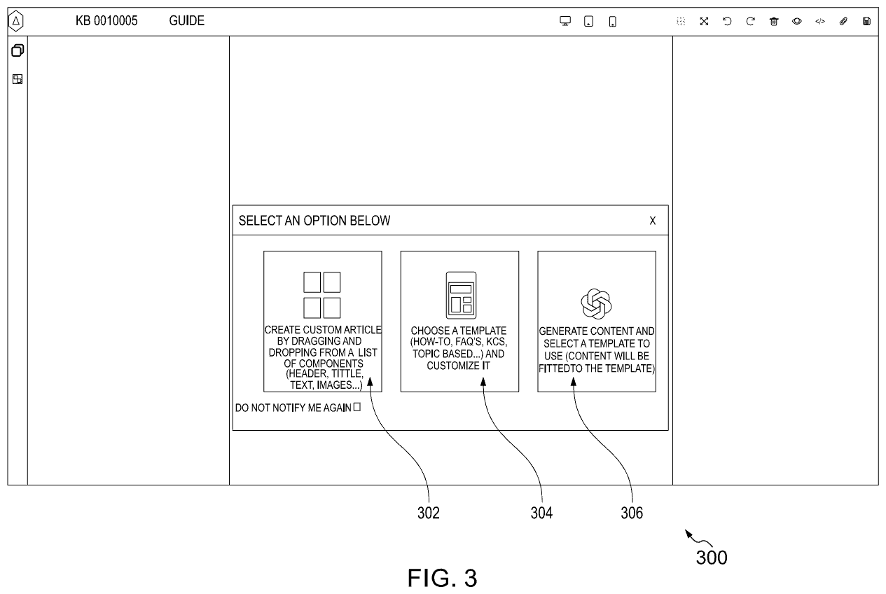

FIG. 3 illustrates an exemplary representation of a UI 300 depicting various article generation methods for generating a new article, in accordance with an embodiment of the present disclosure. It is noted that the UI 300 is rendered on the display of the computing device 106 of the author 104.

UI 300 depicts various article generation methods to the author 104 to choose from before starting with the article generation process. For instance, UI 300 depicts a method 302 which enables the author 104 to create an article on a drag-and-drop-based WYSIWYG editor window. In particular, the method 302 enables the user 104 to create the article based on selection of the one or more components such as header, title, text, element, and the like. For example, if the author 104 wants to insert a title to the article, the author 104 can drag and drop the “title” component to the editor window using a mouse pointer. In addition, the author 104 can drag and drop the “title” component on the required position on the editor screen (i.e., the WYSIWYG editor screen).

UI 300 also depicts a method 304 which enables the author 104 to choose a template from a plurality of pre-existing templates (i.e., template library). The plurality of pre-existing templates may relate to how-to's, FAQs, quizzes, topic-based questions, and the like. In general, a template is a skeleton or format based on which a final document can be produced. The term “template” herein may relate to a format based on which the final article can be generated.

UI 300 may also depict a method 306 which enables the author 104 to use the AI service to generate the article. Upon selection of the method 306, the server system 200 is configured to enable the user (i.e., the author 104) to provide the author request to the extension engine 222. The extension engine 222 is then configured to connect with the Al service to generate AI based recommendations for generation of the article. The AI based recommendations may include recommendations related to the addition of components in the article and their respective content. In one implementation, upon selection of the method 306, the server system 200 enables the author 104 to select a template from the AI service.

In an example, for a blank article, UI 300 displays three options to the author 104. In an implementation, the author 104 can click/press/tap on the first option (i.e., the method 302) to open a UI in the WYSIWYG editor window on the display of the computing device 106. The author 104 can then drag and drop the one or more components on the WYSIWYG editor window to generate the article. In another implementation, the author 104 can click/press/tap on the second option (i.e., the method 304) to open a template UI on the display of the computing device 106. In the template UI, the author 104 is presented with various pre-defined template options to choose from. The author 104 can then search for the required template as per the requirement of the article. In yet another implementation, the author 104 can click/press/tap on the third option (i.e., the method 306) to enable the AI service to generate the article for the author 104.

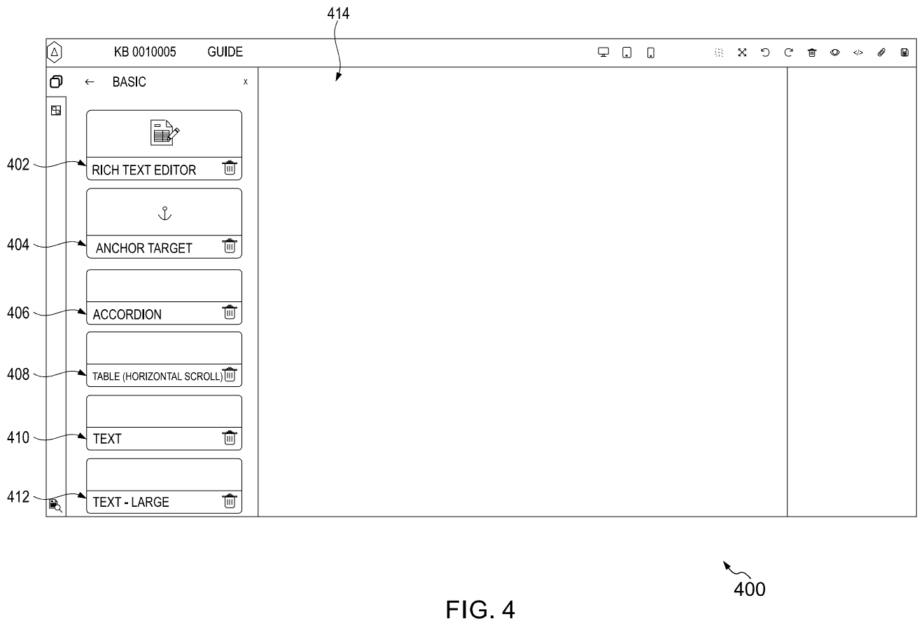

FIG. 4 illustrates an exemplary representation of a UI 400 depicting a set of components, in accordance with an embodiment of the present disclosure. It is noted that UI 400 is rendered on the display of the computing device 106 of the author 104 if the author 104 clicks on the method 302 in UI 300. The author 104 can select the one or more components from the set of components displayed in UI 400. In particular, the author 104 can drag and drop the selected one or more components on the WYSIWYG editor window (see, 414).

For example, the set of components includes Rich Text Editor (see, 402), Anchor Target (see, 404), Accordion (see, 406), Table (Horizontal Scroll) (see, 408), Text (see, 410), Text—large (see, 412), and the like. The author 104 can drag and drop the one or more components from the set of components in the WYSIWYG editor window 414 as per requirement.

In one example, the Rich Text Editor enables the author 104 to edit the text in the article. In one example, the Anchor Target enables the author 104 to add an anchor to the article and also add the links to the anchor. In one example, the Accordion enables the user to add an accordion to the article. In one example, the Table (Horizontal Scroll) enables the author 104 to add a table to the article that can be scrolled in a horizontal manner. In one example, the Text enables the author 104 to add text to the article. In one example, the Text—large enables the author 104 to add text with a comparatively large size to the Text in the article.

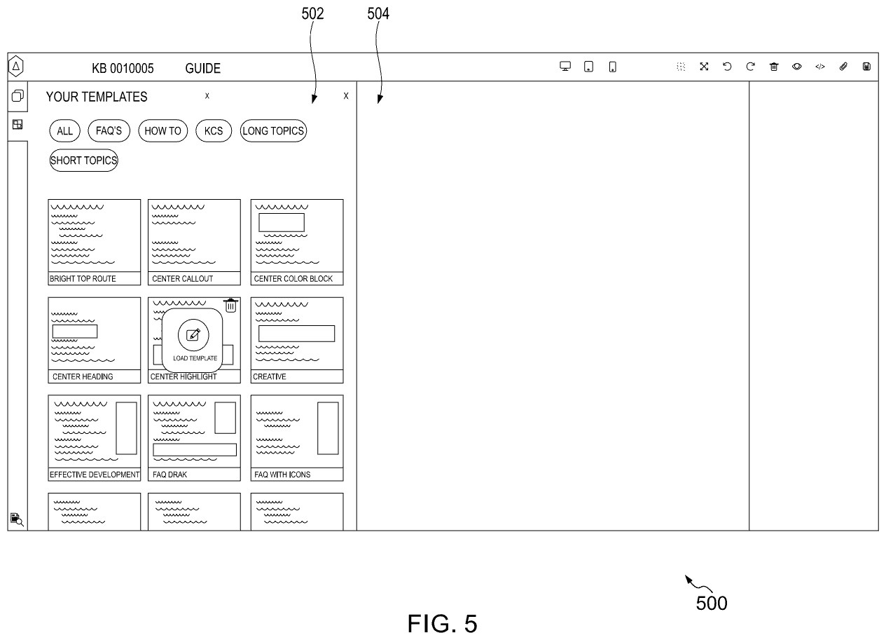

FIG. 5 illustrates an exemplary representation of a UI 500 depicting a plurality of templates, in accordance with an embodiment of the present disclosure. It is noted that the UI 500 is rendered on the display of the computing device 106 of the author 104 if the author 104 clicks on the method 304 in the UI 300. The author 104 can select a template from the plurality of templates displayed in the UI 500. The author 104 can click/press/tap on a template to select the template from the plurality of templates.

As shown in the UI 500, the author 104 is presented with a template panel (see, 502) and an editor screen (i.e., the WYSIWYG editor window) (see, 504). The author 104 may select a template from the plurality of templates as per requirement. The plurality of templates can be categorized into various categories such as “All”, “FAQs”, “How To”, “KCS”, “Long Topics”, “Short Topics”, and the like.

The author 104 can click on a particular category to open pre-stored templates belonging to the selected category. The author 104 can then select a particular template from the plurality of templates displayed on the screen. The author 104 can use an input device (such as mouse, keyboard, etc.) to select the template from the plurality of templates. Once the author 104 selects the template, the template is loaded in the WYSIWYG editor window.

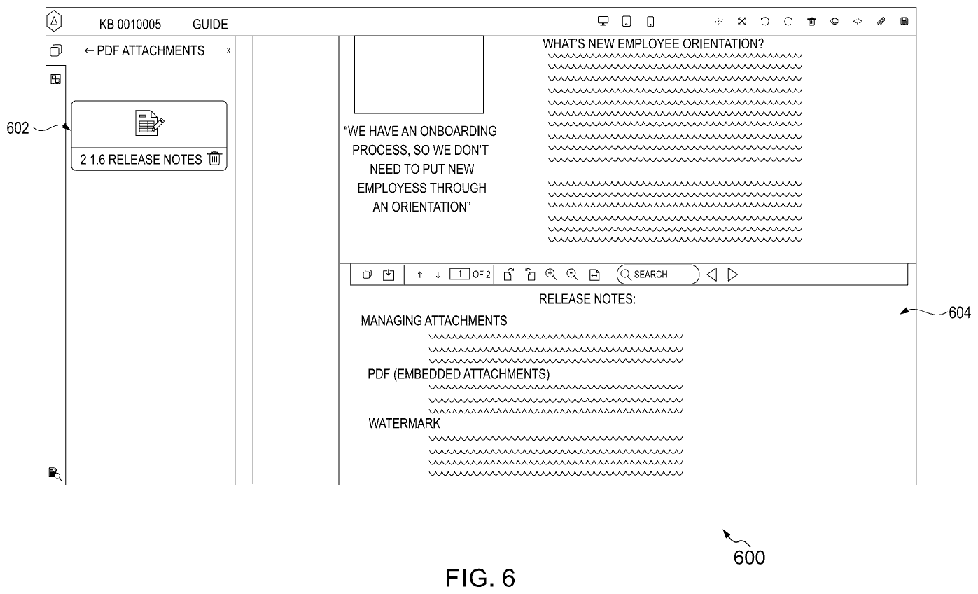

FIG. 6 illustrates an exemplary representation of a UI 600 depicting an embedded document in the article, in accordance with an embodiment of the present disclosure. It is noted that the UI 600 is rendered on the display of the computing device 106 of the author 104 if the author 104 selects the component related to document embedding from the set of components.

As explained above, the article builder application 114 is configured to enable the author 104 to embed a document and/or attachment within the article itself. The embedded document and/or attachment may include any office document, Portable Document Format (PDF), and the like. The document and/or attachment can be embedded within the article itself so that a reader does not have to download the document and/or attachment or open the document and/or attachment in a new window for reading.

As shown in the UI 600, the author 104 is presented with information about the embedded document and/or attachment (see, 602). In addition, the UI 600 displays the actual embedded document and/or attachment in the article (see, 604). The author 104 has an option to drag and drop the embedded document and/or attachment anywhere in the WYSIWYG editor window as per requirement. In one embodiment, the embedded document and/or attachment may have various options such as zoom in, zoom out, rotate clockwise, rotate anti-clockwise, and the like.

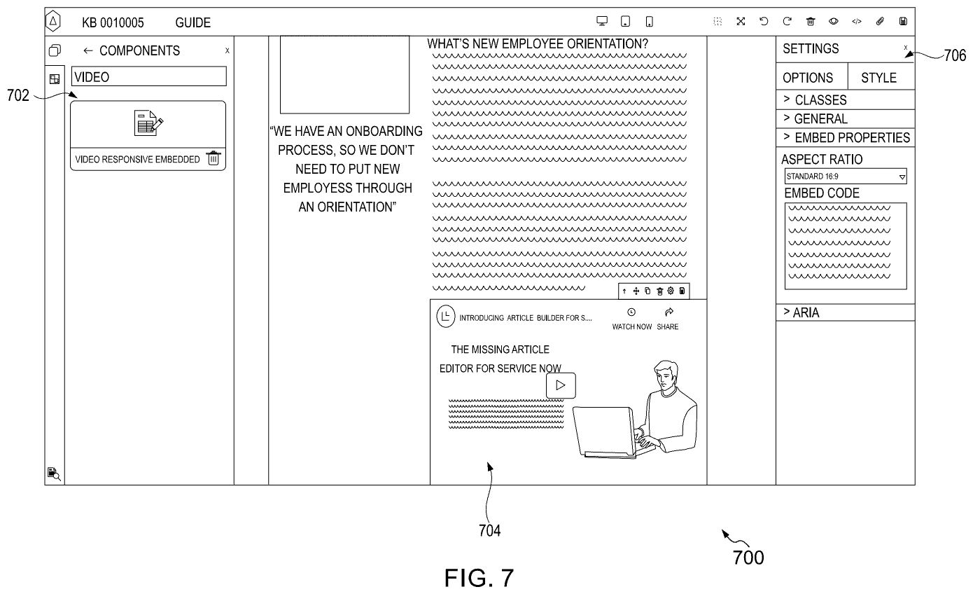

FIG. 7 illustrates an exemplary representation of a UI 700 depicting embedded media content in the article, in accordance with an embodiment of the present disclosure. It is noted that the UI 700 is rendered on the display of the computing device 106 of the author 104 if the author 104 selects the media embedding component from the set of components.

As explained above, the article builder application 114 is configured to enable the author 104 to embed media content within the article itself. With reference to FIG. 7, the media content includes a video. The video can be in any format, aspect ratio, and the like. The video can be embedded within the article itself so that a reader does not have to download the video or open the video in a new window for viewing.

As shown in the UI 700, the author 104 is presented with information about the embedded video (see, 702). In addition, UI 700 displays the actual embedded video in the article (see, 704). The author 104 has an option to drag and drop the embedded video anywhere in the WYSIWYG editor window as per requirement. In one embodiment, UI 700 may also display various settings associated with the embedded video (see, 706). The various settings may include aspect ratio, embed code, and the like.

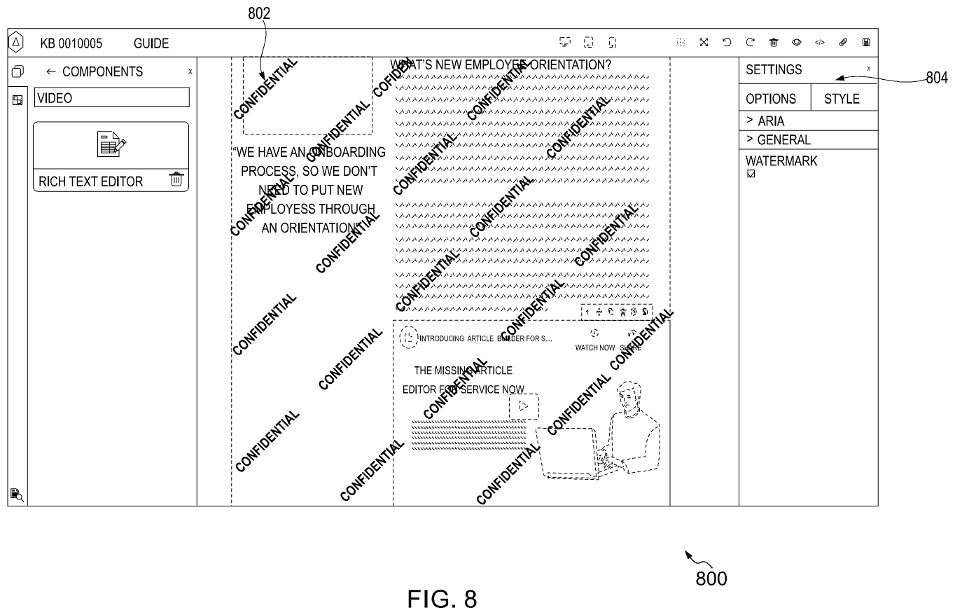

FIG. 8 illustrates an exemplary representation of a UI 800 depicting the article with an embedded watermark, in accordance with an embodiment of the present disclosure. It is noted that UI 800 is rendered on the display of the computing device 106 of the author 104 if the author 104 selects the watermark embedding component from the set of components.

As explained above, the article builder application 114 is configured to enable the author 104 to add a watermark to the article. In one embodiment, the article builder application 114 enables the entity 108 to configure a customized watermark image that can be dynamically generated to show logged-in user information as a watermark to deter leakage of internal information of the entity 108. For example, the watermark can be added to the article as per the requirement of the entity 108. With reference to FIG. 8, the UI 800 displays an exemplary article with a default watermark text “Confidential” (see, 802).

In addition, UI 800 may also display various watermark settings (see, 804) to change options and styles associated with the watermark. The various settings may include font size, font style, a direction of the watermark, color options, font format, and the like. In one example, the various settings may include a checkbox to turn on or off the watermark.

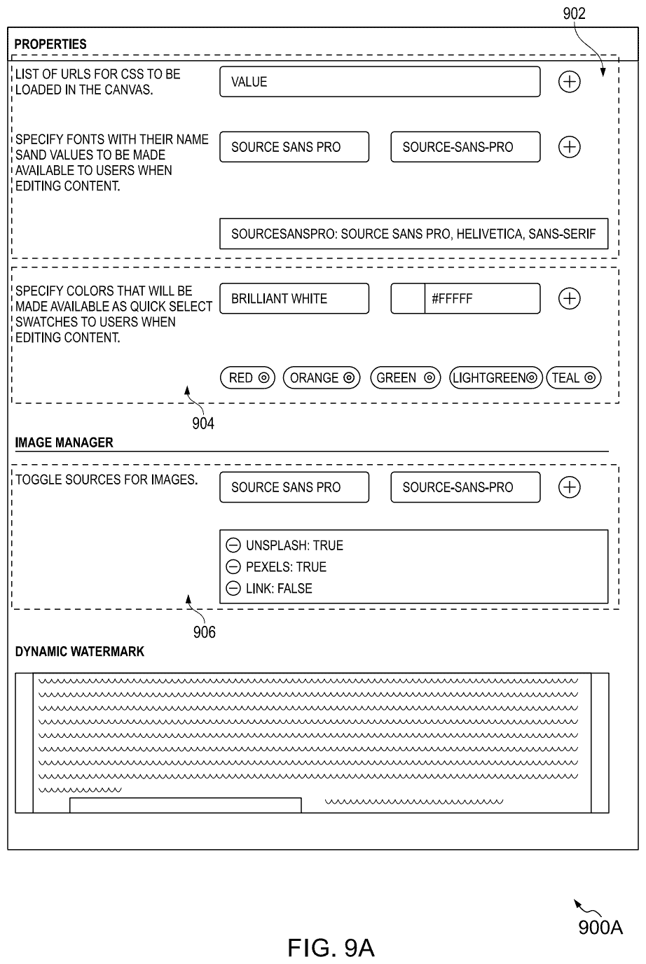

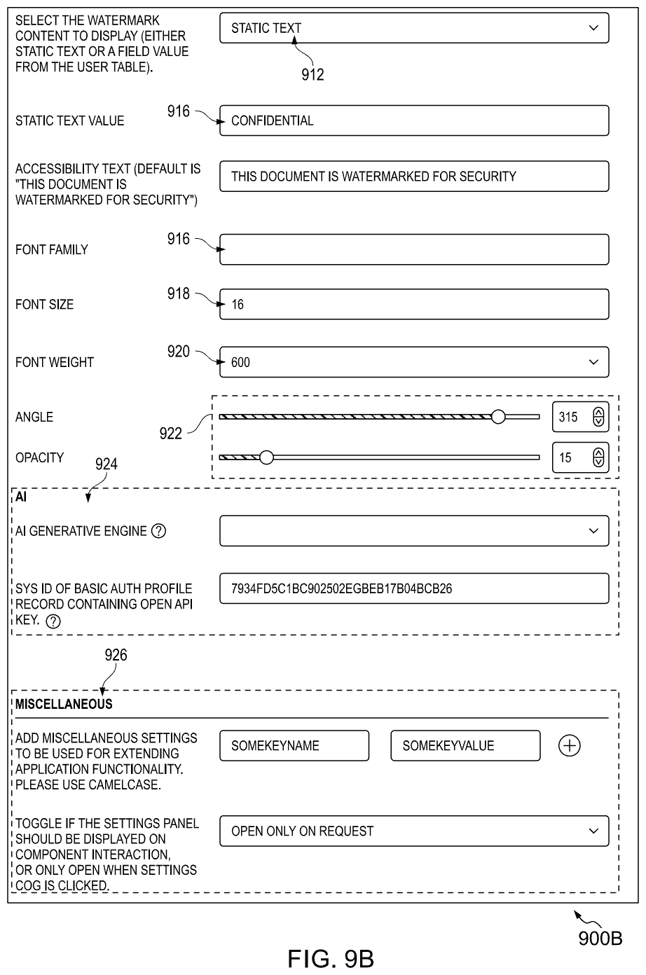

FIG. 9A-9B collectively illustrates UI 900A-900B depicting various settings associated with the article builder application 114, in accordance with an embodiment of the present disclosure. It is noted that the UI 900 is rendered on the display of the computing device 106 of the author 104 if the author 104 wants to change internal settings of the article builder application 114. In one example, the internal settings may include settings related to access control of specific authors on the existing templates and components.

For example, UI 900A depicts font recommendations (see, 902) that the author 104 can select, such that the selected fonts can be made available to the author 104 during editing content for the article. In addition, UI 900A depicts color recommendations (see, 904) that the author 104 can select, such that the selected colors can be made available to the author 104 during editing content for the article. Further, UI 900A depicts toggle sources for images (see, 906).

UI 900B depicts a drop-down menu (see, 912) that enables the author 104 to specify the watermark content to display on the generated article. For example, the watermark content can be either static text or a field value. In addition, UI 900B depicts a text-box (see, 914) that enables the author 104 to define the static text value. Further, UI 900B depicts a text-box (see, 916) that enables the author 104 to specify a default font family. Furthermore, UI 900B depicts a text-box (see, 918) that enables the author 104 to specify a default font size. Moreover, UI 900B depicts a text-box (see, 920) that enables the author 104 to specify a default font weight. Also, UI 900B depicts various settings (see, 922) related to angle and opacity of the text of the content. Also, UI 900B depicts various settings (see, 924) associated with the artificial intelligence service. Also, UI 900B depicts miscellaneous settings (see, 926) associated with the article generation.

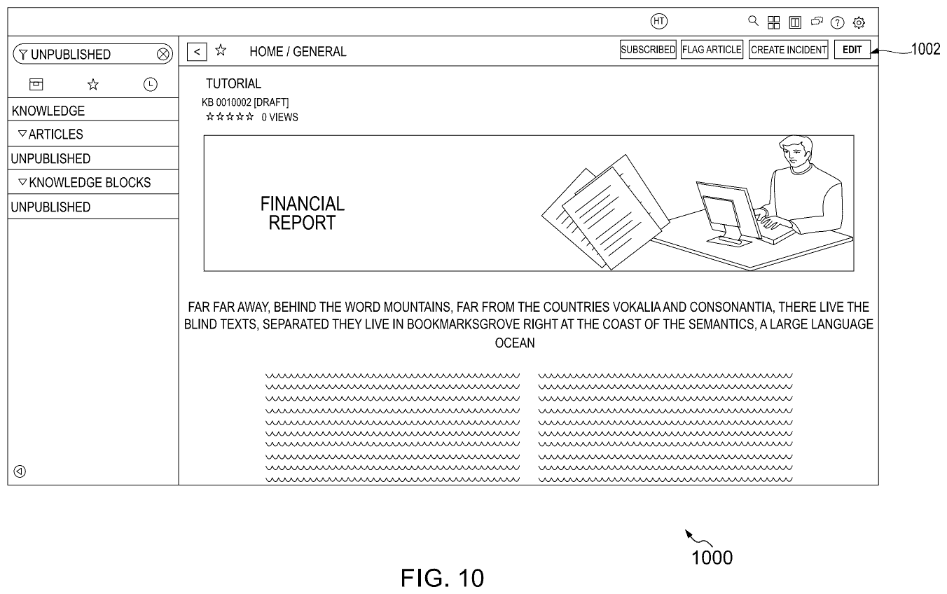

FIG. 10 illustrates a UI 1000 depicting a preview of the article, in accordance with an embodiment of the present disclosure. It is noted that the UI 1000 displays a preview of the article upon completion. The author 104 can preview the article to see how the article will look on the computing device 106 (e.g., a mobile phone, a computer, a laptop, a tablet, etc.) of a reader.

As shown in the UI 1000, the article is displayed on the display of the computing device 106 of the author 104. In addition, the UI 1000 includes an “Edit” button (see, 1202) that enables the author 104 to edit the article. The author 104 may click on the “Edit” button to add text, remove text, change formatting, add or remove media elements, add or remove the watermark, and so on.

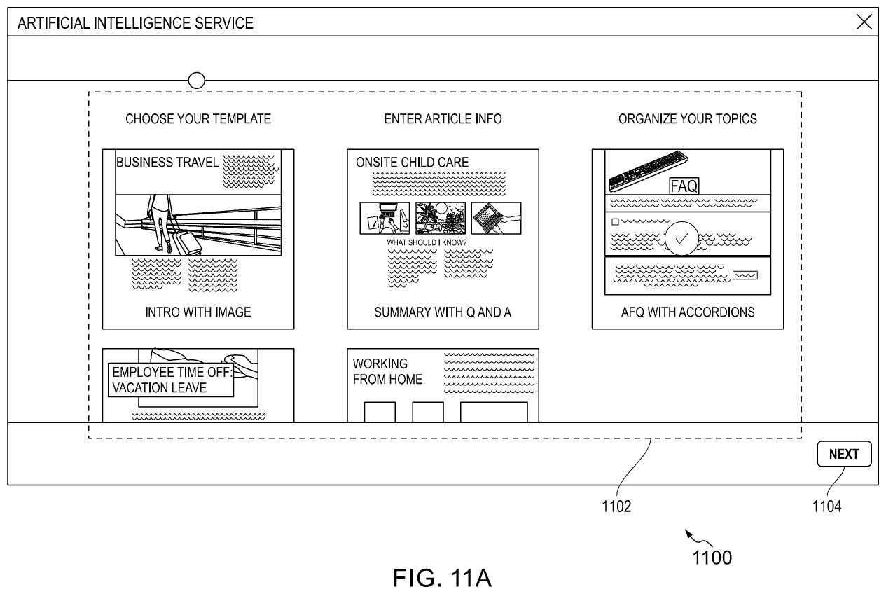

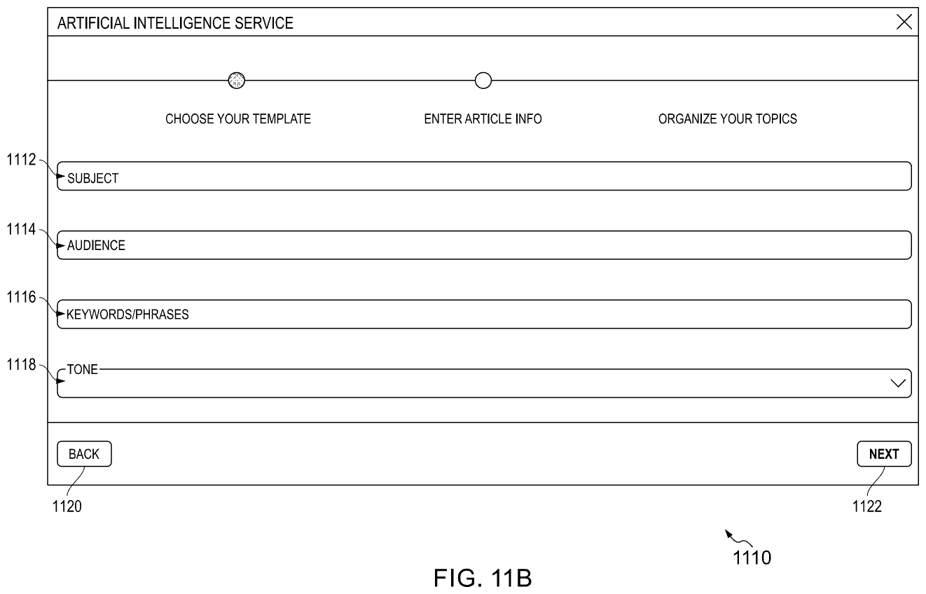

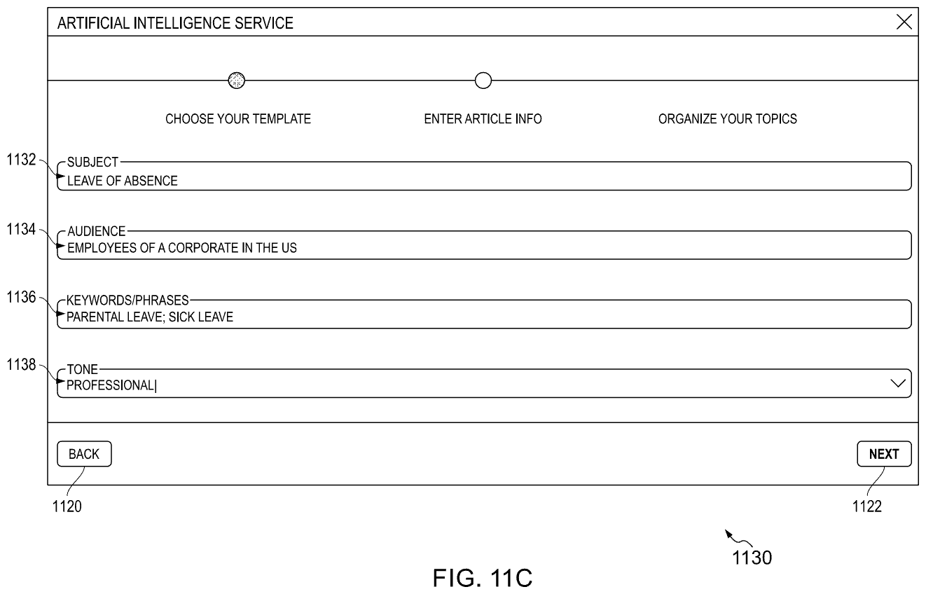

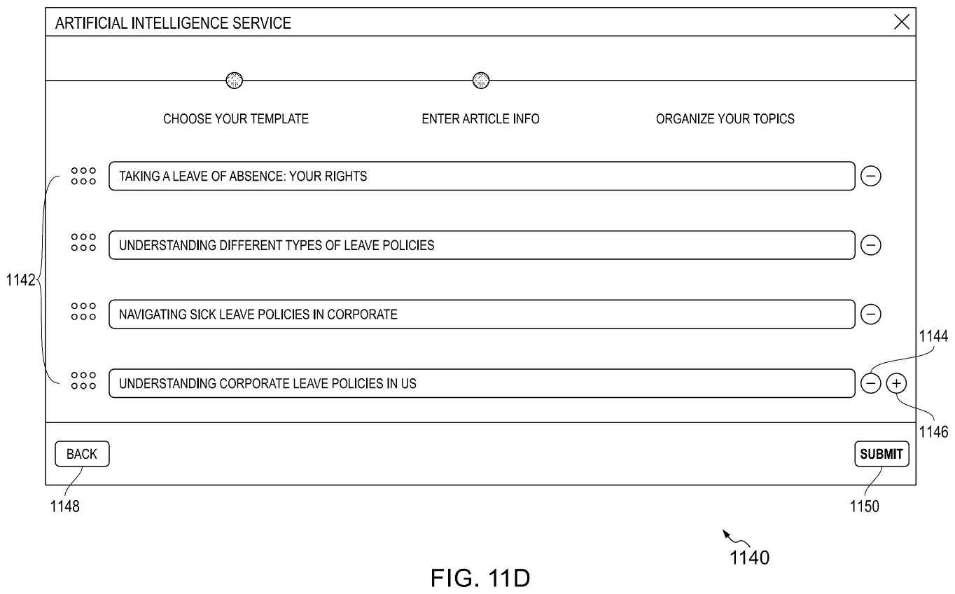

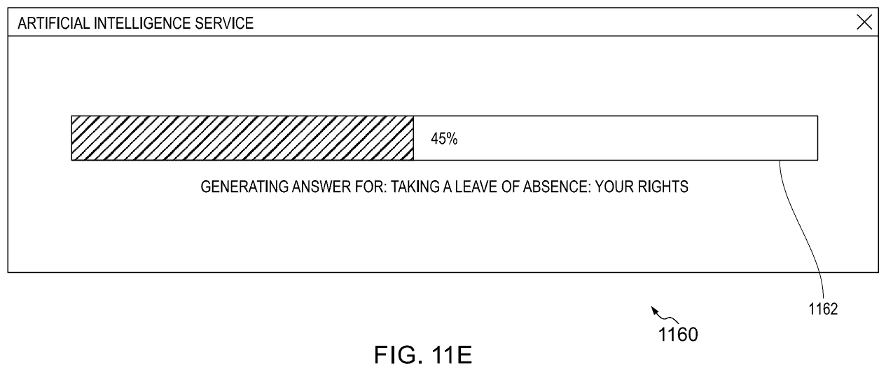

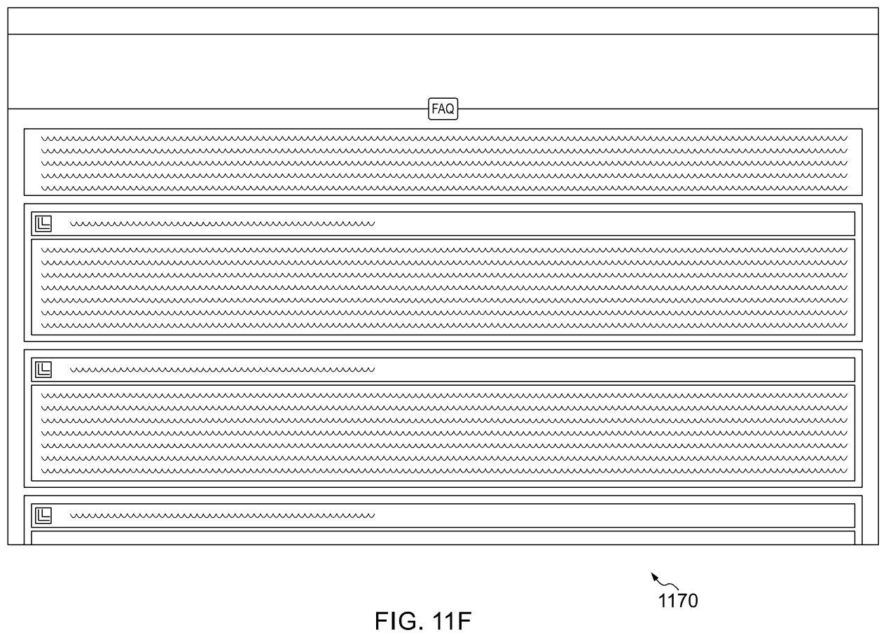

FIG. 11A illustrates an example representation of user interface (UI) 1100 rendered on the display of the computing device 106 of the author 104 when the author 104 selects the artificial intelligence service to generate the article. For example, UI 1100 is rendered on the display of the computing device 106 when the author 104 clicks on the option 306 in UI 300.

UI 1100 depicts various templates (see, 1102) on the computing device 106 of the author 104. The author 104 can then select any template from the various templates as per requirement. In an embodiment, the artificial intelligence service is configured to display the various templates on the computing device 106 of the author 104. In another embodiment, the artificial intelligence service is configured to display the various templates on the computing device 106 of the author 104.

The author 104 can click/press/tap on the desired template to select the corresponding template. Once the author 104 selects the desired template, the author 104 can click/press/tap on the “next” button (see, 1104). Once the author 104 clicks/presses/taps on the “next” button, UI 1110 is rendered on the display of the computing device 106 of the author 104.

FIG. 11B illustrates an example representation of user interface (UI) 1110 for receiving the author request from the author 104. UI 1110 is rendered on the display of the computing device 106 when the author 104 clicks on the “next” button in UI 1100.

For example, UI 1110 depicts a text box (see, 1112) to receive the subject of the required article from the author 104. In addition, UI 1110 depicts a text box (see, 1114) to receive the target audience of the required article from the author 104. Further, UI 1110 depicts a text box (see, 1116) to receive the relevant keywords for the required article from the author 104. Furthermore, UI 1110 depicts a text box (see, 1118) to receive the desired tone of the required article from the author 104.

Moreover, the author 104 has an option to click/press/tap on the “back button” (see, 1120) to go back to the previous UI 1100.

FIG. 11C illustrates an example representation of user interface (UI) 1130 depicting received author request from the author 104. In an example, UI 1130 depicts UI 1110 with received author request from the author 104. For example, UI 1130 depicts a text box with received subject (see, 1132) from the author 104. In addition, UI 1130 depicts a text box with received target audience (see, 1134) from the author 104. Further, UI 1130 depicts a text box with received relevant keywords (see, 1136) from the author 104. Furthermore, UI 1130 depicts a text box with received desired tone (see, 1138) from the author 104.

Once the author 104 enters the above-mentioned information, the author 104 has an option to click/press/tap on the “next button” (see, 1122) to proceed to the next UI (i.e., UI 1140).

FIG. 11D illustrates an example representation of user interface (UI) 1140 depicting the generated list of relevant topics on the display of the computing device 106 of the author 104. The artificial intelligence service is configured to process the author request based at least on the AI service to generate the list of relevant topics. The generated list of relevant topics (see, 1142) is then rendered on the display of the computing device 106.

The author 104 can click/press/tap on a remove button (see, 1144) to remove a corresponding topic from the generated list of relevant topics. Moreover, the author 104 can click/press/tap on an add button (see, 1146) to add a corresponding topic to the generated list of relevant topics. The author 104 can click/press/tap on the “back button” (see, 1148) to go back to the previous UI 1130. Once the author 104 is satisfied with the generated list of relevant topics, the author 104 can click/press/tap on the “submit button” (see, 1150) to go to the next UI 1160.

FIG. 11E illustrates an example representation of user interface (UI) 1160 depicting processing for generation of the article. UI 1160 is rendered on the display of the computing device 106 of the author 104 once the author 104 clicks/presses/taps on the “submit button” in UI 1150.

UI 1160 depicts a progress bar (see, 1162) depicting the progress of the processing for generation of the article. For example, UI 1160 depicts that 45% of the processing is complete for the generation of the article based on the inputs received in UI 1140.

FIG. 11F illustrates an example representation of user interface (UI) 1170 depicting the generated article. In an implementation, the generated article is rendered on the display of the computing device 106 of the author 104. The author 104 can then preview the article.

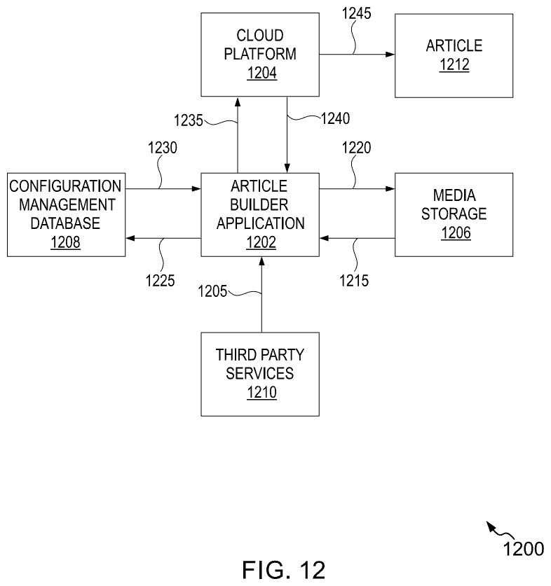

FIG. 12 illustrates a block diagram representation 1200 of enabling the author 104 to create the article, in accordance with an embodiment of the present disclosure. The block diagram representation 1200 includes an article builder application 1202 (e.g., the article builder application 114 of FIG. 1), a cloud platform 1204, a media storage 1206, a configuration management database 1208, third-party services 1210, and an article 1212.

In one example, the article builder application 1202 may communicatively be coupled to the cloud platform 1204, the media storage 1206, the configuration management database 1208, the third-party services 1210, and the article 1212 via a network (e.g., the network 110). The article builder application 1202 may create an interface with third-party service integration (see, 1205). The third-party services 1210 may include artificial intelligence tools (e.g., the AI service), spell checkers, Optical Character Recognition (OCR) readers, translation assistants, voice assistants, media libraries, and the like. The third-party services 1210 can be embedded into the article 1212.

In one implementation, the article builder application 1202 is configured to create a media gallery from user custom media content (see, 1215). The user custom media content may relate to user-uploaded media content. The media content can be in the form of documents, images, videos, audios, and the like. For example, the media content can be personal audio recordings of the author, video content, podcasts, and the like.

The article builder application 1202 is also configured to save user-generated content in the media storage 1206 (see, 1220). For example, the author 104 can upload the user custom media content to generate the article 1212 and then save the user-generated content (e.g., the user custom media content) to the media storage 1206 so that the user custom media content can be reused by other authors. The article builder application 1202 may communicate with the media storage 1206 over the network (e.g., the network 110).

In one implementation, the configuration management database 1208 is configured to provide Out-Of-Band (OOB) data and custom UI elements that the author 104 has access to, to the article builder application 1202 (see, 1225). In one implementation, the article builder application 1202 is configured to save custom UI elements (e.g., components, templates, etc.) in the configuration management database 1208 (see, 1230). In one example, the configuration management database 1208 is the database 112 of FIG. 1.

In one implementation, the cloud platform 1204 is configured to send the formatted article content (e.g., Hyper-text Markup Language (HTML), markdown, etc.) to the article builder application 1202 (see, 1235). In one implementation, the article builder application 1202 is configured to save the article 1212 (along with the media content) in the cloud platform 1204 (see, 1240). The cloud platform 1204 is then configured to select the requested article (i.e., the article 1212) (see, 1245).

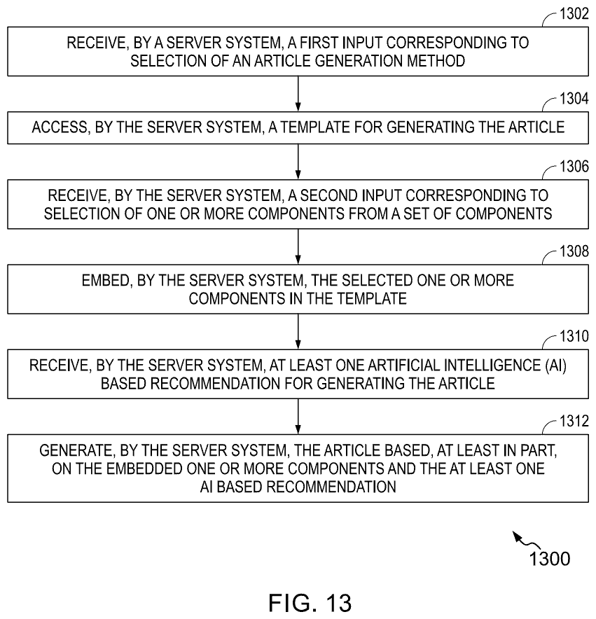

FIG. 13 is a flowchart illustrating a computer-implemented method 1300 for enabling the author 104 to generate an article, in accordance with an embodiment of the present disclosure. The method 1300 depicted in the flowchart may be executed by, for example, at least one server system 200. Operations of the flowchart of the method 1300, and combinations of operations in the flow diagram of the method 1300, may be implemented by, for example, hardware, firmware, a processor, circuitry, and/or a different device associated with the execution of software that includes one or more computer program instructions. The method 1300 starts at operation 1302.

At 1302, the method 1300 includes receiving, by the server system 200, the first input corresponding to selection of an article generation method. The first input may be received from the computing device 106 of the author 104. In particular, a Graphical User Interface (GUI) is rendered on the display of the computing device 106 of the author 104. In one example, GUI allows the author 104 to select one article generation method from three article generation methods to generate the article. The author 104 can select the article generation method as per requirement.

At 1304, the method 1300 includes accessing, by the server system 200, the template for generating the article.

At 1306, the method 1300 includes receiving, by the server system 200, the second input corresponding to selection of one or more components from the set of components. In one implementation, the second input corresponds to the one or more components selected from the set of components by the author 104. For example, the author 104 may choose the one or more components from the set of components to be used for the article. In various embodiments, the one or more components may include videos, documents, knowledge blocks, accordions, anchors, dynamic services, and the like.

At 1308, the method 1300 includes embedding, by the server system 200, the selected one or more components in the template. In particular, the selected one or more components are embedded in the article based on the user input (i.e., the author 104 can drag and drop the one or more components anywhere in the article as per requirement).

At 1310, the method 1300 includes receiving, by the server system 200, at least one artificial intelligence (AI) based recommendation for generating the article. The server system 200 may also receive media recommendations from the library.

At 1312, the method 1300 includes generating, by the server system 200, the article based, at least in part, on the embedded one or more components, and the at least one AI based recommendation.

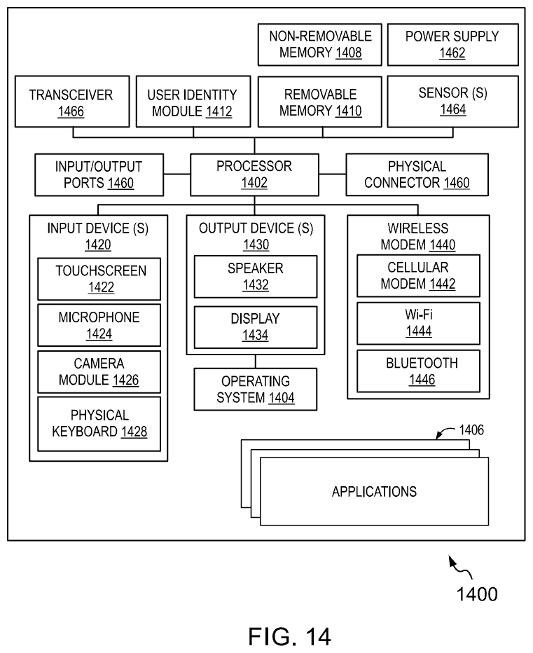

FIG. 14 shows a simplified block diagram of a computing device 1400 (for example a mobile phone or a desktop computer) capable of implementing the various embodiments of the present disclosure. For example, the computing device 1400 may correspond to the computing device 106 of FIG. 1. The computing device 1400 is depicted to include one or more applications 1406 (e.g., the article builder application 114) facilitated by the server system 102. The article builder application 114 can be an instance of an application downloaded from the server system 102 or a third-party server. The article builder application 114 is capable of communicating with the server system 102 for generating the article for the author 104 and/or the entity 108 as per their requirement. In addition, the article builder application 114 is capable of displaying the generated article on the display of the computing device 1400 of the author 104 and/or the entity 108.

It should be understood that the computing device 1400 as illustrated and hereinafter described is merely illustrative of one type of device and should not be taken to limit the scope of the embodiments. As such, it should be appreciated that at least some of the components described below in connection with the computing device 1400 may be optional, and thus in an example embodiment may include more, less, or different components than those described in connection with the embodiment of FIG. 14. As such, among other examples, the computing device 1400 could be any of a mobile electronic device, for example, cellular phones, tablet computers, laptops, mobile computers, Personal Digital Assistants (PDAs), mobile televisions, mobile digital assistants, or any combination of the aforementioned, and other types of communication or multimedia devices.

The illustrated computing device 1400 includes a controller or a processor 1402 (e.g., a signal processor, microprocessor, ASIC, or other control and processing logic circuitry) for performing such tasks as signal coding, data processing, image processing, input/output processing, power control, and/or other functions. An operating system 1404 controls the allocation and usage of the components of the computing device 1400 and supports one or more applications programs such as the article builder application 114, that implements one or more of the innovative features described herein. In addition to the article builder application 114, the applications may include common mobile computing applications (e.g., telephony applications, email applications, calendars, contact managers, web browsers, messaging applications) or any other computing application.

The illustrated computing device 1400 includes one or more memory components, for example, a non-removable memory 1408 and/or removable memory 1410. The non-removable memory 1408 and/or the removable memory 1410 may be collectively known as a database in an embodiment. The non-removable memory 1408 can include RAM, ROM, flash memory, a hard disk, or other well-known memory storage technologies. The removable memory 1410 can include flash memory, smart cards, or a Subscriber Identity Module (SIM). The one or more memory components can be used for storing data and/or code for running the operating system 1404 and the article builder application 114. The computing device 1400 may further include a User Identity Module (UIM) 1412. The UIM 1412 may be a memory device having a processor built in. The UIM 1412 may include, for example, a subscriber identity module (SIM), a Universal Integrated Circuit Card (UICC), a Universal Subscriber Identity Module (USIM), a Removable User Identity Module (R-UIM), or any other smart card. The UIM 1412 typically stores information elements related to a mobile subscriber. The UIM 1412 in form of the SIM card is well known in Global System for Mobile (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The computing device 1400 can support one or more input devices 1420 and one or more output devices 1430. Examples of the input devices 1420 may include, but are not limited to, a touch screen/a display screen 1422 (e.g., capable of capturing finger tap inputs, finger gesture inputs, multi-finger tap inputs, multi-finger gesture inputs, or keystroke inputs from a virtual keyboard or keypad), a microphone 1424 (e.g., capable of capturing voice input), a camera module 1426 (e.g., capable of capturing still picture images and/or video images) and a physical keyboard 1428. Examples of the output devices 1430 may include, but are not limited to, a speaker 1432 and a display 1434. Other possible output devices 1430 can include piezoelectric or other haptic output devices. Some devices can serve more than one input/output function. For example, the touch screen 1422 and the display 1434 can be combined into a single input/output device.

A wireless modem 1440 can be coupled to one or more antennas (not shown in FIG. 14) and can support two-way communications between the processor 1402 and external devices, as is well understood in the art. The wireless modem 1440 is shown generically and can include, for example, a cellular modem 1442 for communicating at long range with the mobile communication network, a Wi-Fi compatible modem 1444 for communicating at short range with an external Bluetooth-equipped device or a local wireless data network or router, and/or a Bluetooth-compatible modem 1446. The wireless modem 1440 is typically configured for communication with one or more cellular networks, such as a GSM network for data and voice communications within a single cellular network, between cellular networks, or between the computing device 1400 and a Public Switched Telephone Network (PSTN).

The computing device 1400 can further include one or more input/output ports 1450, a power supply 1452, one or more sensors 1454 for example, an accelerometer, a gyroscope, a compass, or an infrared proximity sensor for detecting the orientation or motion of the computing device 1400 and biometric sensors for scanning biometric identity of an authorized user, a transceiver 1456 (for wirelessly transmitting analog or digital signals) and/or a physical connector 1460, which can be a USB port, IEEE 794 (FireWire) port, and/or RS-232 port. The illustrated components are not required or all-inclusive, as any of the components shown can be deleted and other components can be added.

The disclosed method with reference to FIG. 13, or one or more operations of the method 1300 may be implemented using software including computer-executable instructions stored on one or more computer-readable media (e.g., non-transitory computer-readable media, such as one or more optical media discs, volatile memory components (e.g., DRAM or SRAM)), or nonvolatile memory or storage components (e.g., hard drives or solid-state nonvolatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, Complementary Metal Oxide Semiconductor (CMOS) based logic circuitry), firmware, software, and/or any combination of hardware, firmware, and/or software (for example, embodied in a machine-readable medium). For example, the apparatuses and methods may be embodied using transistors, logic gates, and electrical circuits (for example, Application-Specific Integrated Circuit (ASIC) circuitry and/or in Digital Signal Processor (DSP) circuitry).

Particularly, the server system 200 and its various components such as the computer system 202 and the database 204 may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or the computer to perform one or more operations. A computer-readable medium storing, embodying, or encoded with a computer program, or similar language may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media include any type of tangible storage media. Examples of non-transitory computer-readable media include magnetic storage media (such as floppy disks, magnetic tapes, hard disk drives, etc.), optical magnetic storage media (e.g., magneto-optical disks), Compact Disc Read Only Memory (CD-ROM), compact disc recordable (CD-R), Compact Disc Rewritable (CD-R/W), Digital Versatile Disc (DVD), BLU-RAY® Disc (BD), and semiconductor memories (such as mask ROM, programmable ROM (PROM), erasable PROM (EPROM), flash memory, Random Access Memory (RAM), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method for generating an article, the method comprising:
receiving, by a server system, a first input corresponding to selection of an article generation method;
accessing, by the server system, a template for generating the article;
receiving, by the server system, a second input corresponding to selection of one or more components from a set of components;
embedding, by the server system, the selected one or more components in the template;
receiving, by the server system, at least one Artificial Intelligence (AI) based recommendation for generating the article; and
generating, by the server system, the article based, at least in part, on the embedded one or more components and the at least one AI based recommendation.

2. The computer-implemented method as claimed in claim 1, further comprising rendering, by the server system, a User Interface (UI) on a computing device, wherein the rendered UI depicts a What You See Is What You Get (WYSIWYG) editor window rendered on the computing device.

3. The computer-implemented method as claimed in claim 2, wherein the second input is received via the WYSIWYG editor window.

4. The computer-implemented method as claimed in claim 1, further comprising:
establishing, by the server system, a secure communication with an AI service and library via Representational State Transfer Application Programming Interface (RESTful API); and
receiving, by the server system, the at least one AI based recommendation and media components from the AI service and library for generating the article.

5. The computer-implemented method as claimed in claim 1, wherein for receiving the at least one AI based recommendation, the method further comprises:
receiving, by the server system, an author request comprising at least one of: subject of the article, relevant keywords, target audience for the article, and desired tone of the article;
processing, by the server system, the author request via the AI service to generate a list of relevant topics, wherein the generated list of relevant topics is rendered on a display of the computing device;
receiving, by the server system, an author response comprising selection of one or more topics from the generated list of relevant topics;
updating, by the server system, Document Object Model (DOM) of the template based at least on the author response; and
mapping, by the server system, each section of the DOM to custom attributes.

6. The computer-implemented method as claimed in claim 5, further comprising:
receiving, by the server system, content requests from the computing device, wherein the content requests are related to content for each section of the DOM;
processing, by the server system, the content requests via the AI service to generate content responses; and
generating, by the server system, the article based at least on the generated content responses.

7. The computer-implemented method as claimed in claim 1, further comprising:
calculating, by the server system, one or more health scores associated with one or more published articles, wherein the calculation of the one or more health scores is performed based at least on analysis of one or more parameters.

8. The computer-implemented method as claimed in claim 7, wherein the one or more parameters comprise at least one of orphaned articles, unused articles, least read articles, most popular articles, and search unclicked articles.

9. The computer-implemented method as claimed in claim 1, wherein the one or more components comprise at least one of carousels, tabs, media elements, embedding documents, knowledge blocks, accordions, anchors, and dynamic services.

10. The computer-implemented method as claimed in claim 1, further comprising rendering, by the server system, the generated article on a display of the computing device.

11. A server system, comprising:
a memory configured to store instructions;
a communication interface; and
a processor in communication with the memory and the communication interface, the processor configured to execute the instructions stored in the memory and thereby cause the server system to perform, at least in part, to:
receive a first input corresponding to selection of an article generation method;
access a template to generate the article;
receive a second input corresponding to selection of one or more components from a set of components;
embed the selected one or more components in the template;
receive at least one Artificial Intelligence (AI) based recommendation to generate the article; and
generate the article based, at least in part, on the embedded one or more components and the at least one AI based recommendation.

12. The server system as claimed in claim 11, wherein the server system is further caused to render a User Interface (UI) on a computing device, wherein the rendered UI depicts a What You See Is What You Get (WYSIWYG) editor window rendered on the computing device.

13. The server system as claimed in claim 12, wherein the second input is received via the WYSIWYG editor window.

14. The server system as claimed in claim 11, wherein the server system is further caused to:
establish a secure communication with an AI service and library via Representational State Transfer Application Programming Interface (RESTful API); and
receive the at least one AI based recommendation and media components from the AI service and library to generate the article.

15. The server system as claimed in claim 11, wherein to receive the at least one AI based recommendation, the server system is further caused to:
receive an author request comprising at least one of: subject of the article, relevant keywords, target audience for the article, and desired tone of the article;
process the author request via the AI service to generate a list of relevant topics, wherein the generated list of relevant topics is rendered on a display of the computing device;
receive an author response comprising selection of one or more topics from the generated list of relevant topics;
update Document Object Model (DOM) of the template based at least on the author response; and
map each section of the DOM to custom attributes.

16. The server system as claimed in claim 15, wherein the server system is further caused to:
receive content requests from the computing device, wherein the content requests are related to content for each section of the DOM;
process the content requests via the AI service to generate content responses; and
generate the article based at least on the generated content responses.

17. The server system as claimed in claim 11, wherein the server system is further caused to:
calculate one or more health scores associated with one or more published articles, wherein the calculation of the one or more health scores is performed based at least on analysis of one or more parameters.

18. The server system as claimed in claim 17, wherein the one or more parameters comprise at least one of orphaned articles, unused articles, least read articles, most popular articles, and search unclicked articles.

19. The server system as claimed in claim 11, wherein the one or more components comprise at least one of carousels, tabs, media elements, embedding documents, knowledge blocks, accordions, anchors, and dynamic services.

20. The server system as claimed in claim 11, wherein the server system is further caused to render the generated article on a display of the computing device.
